(19) United States
(12) Patent Application Publication
(10) Pub. No.: US 2015/0323641 A1
(43) Pub. Date: Nov. 12, 2015

(54) LOCATION DETECTION SYSTEM METHOD AND APPARATUS

(71) Applicant: LEON SALINAS, Wortham, TX (US)

(72) Inventor: LEON SALINAS, Wortham, TX (US)

(21) Appl. No.: 14/271,432

(22) Filed: May 6, 2014

(51) Int. Cl. G01S 1/68; B60Q 5/00; B60Q 1/00

(52) U.S. Cl. CPC G01S 1/68; B60Q 1/00; B60Q 5/005

(57) ABSTRACT

The present application relates to an emergency location system for transportation vessels. The vessels are either aircraft or watercraft. The system includes an elevation device and a tether used to couple the elevation device to the aircraft or watercraft. The length of the tether is adjustable before and after an emergency has occurred. The elevation device is used to elevate beacons and visual indicators relative to the vessel to increase the detectability. An automated control system regulates deployment and operation of the tether and elevation device.

### BACKGROUND

1. Field of the Invention

The present application relates generally to large scale transportation vessels and, more particularly, to a location detection system used on aircraft and watercraft.

2. Description of Related Art

The transportation industry uses multiple types of large scale transportation vessels, such as trains, planes, watercraft and so forth. These vessels are used to transport people, cargo (manufactured goods), produce, and livestock around the world. At times, accidents may occur which may leave the vessel powerless and damaged. These vessels may be lost at sea and sink, leaving little trace of the wreckage. If wreckage is discovered on the surface of the water, currents have typically dispersed portions of the vessel over extreme distances leading to vast search areas. If wreckages occur on rough terrain, wreckages may be hidden due to blending scenery, fresh snow, thick overgrowth of vegetation, and so forth. In both instances, discovering the wreckage can become extremely difficult, time consuming, and costly.

Presently, systems exist that permit tracking of a vessel. These may be used to identify the location of a portion of the vessel. Such systems typically include a sound beacon or transmitted signal. These systems have some disadvantages. For instance, beacons or signal emitters are typically located directly within the wreckage. When under water, the depth of the wreckage and salinity of the water make it difficult to accurately detect from the surface. Furthermore, the emitters have limited life spans. Additionally, some of these systems may be overridden by a user and shut off.

A more robust and easily detectable detection system is required to reduce the time and cost required to determine the wreckage site. Although great strides have been made in detection systems for vessels, considerable shortcomings remain.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a schematic of an emergency location system according to the preferred embodiment of the present application;

FIG. 2 is a top view and side view of an aircraft with the emergency location system of FIG. 1;

FIG. 3 is a side view of a second aircraft with the emergency location system of FIG. 1;

FIG. 4 is a side view of a watercraft with the emergency location system of FIG. 1;

FIG. 5 is a side view of the emergency location system of FIG. 1 deployed relative to a vessel; and

FIG. 6 is a side view of an alternative embodiment of the emergency location system of FIG. 1 deployed relative to the vessel.

While the system and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

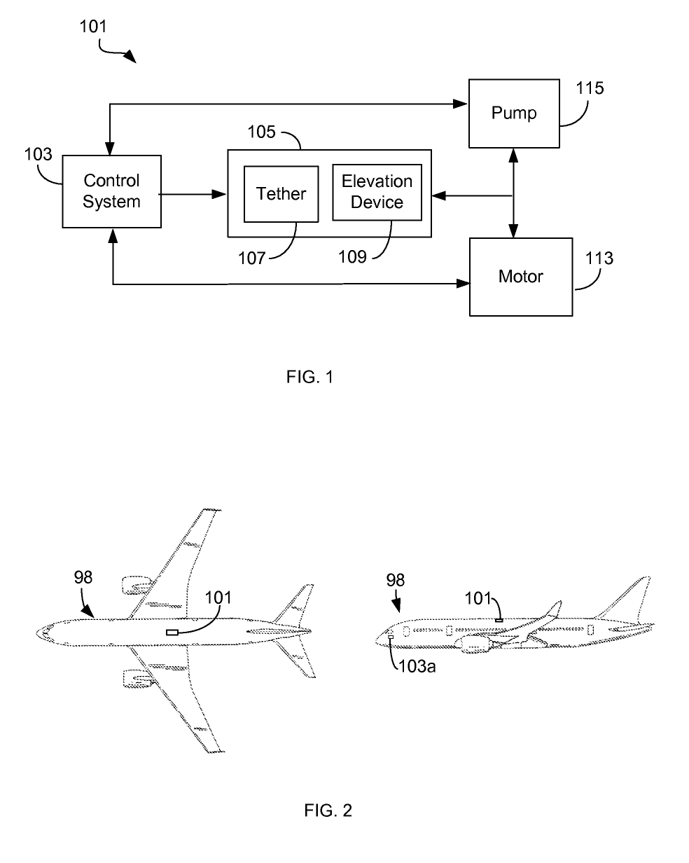

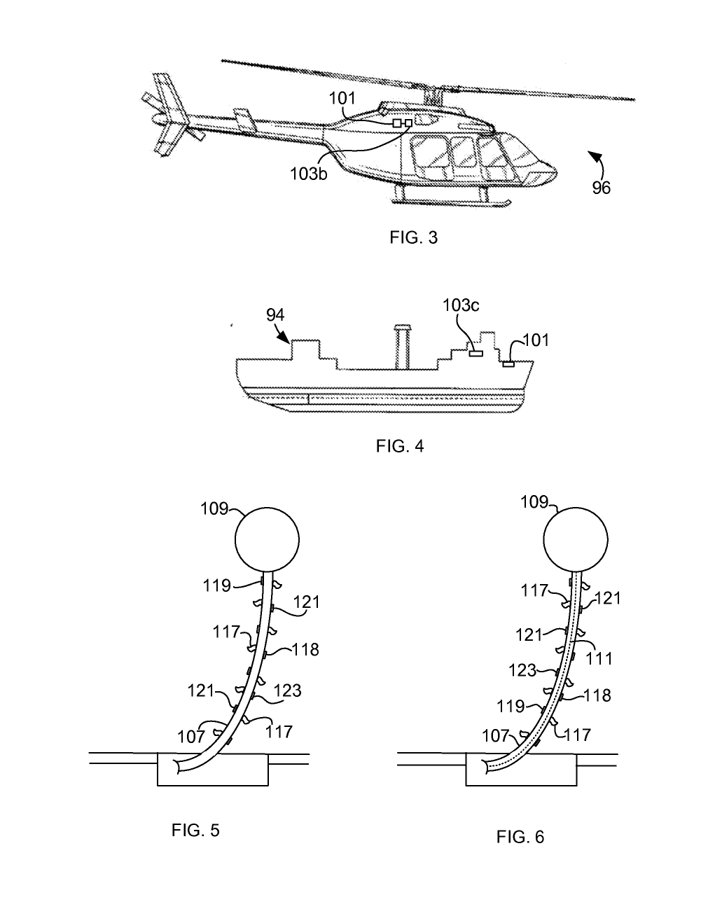

Referring now to FIGS. 1-4 in the drawings, a location detection system 101 is illustrated. System 101 is used in combination with transportation vessels to aid in the rapid response and recovery of lives and cargo by reducing the time and cost of determining the location of a wreckage site. As seen in FIGS. 2-4, system 101 is configured to be installed and operable with aircraft and watercraft, namely at least a plane 98, a helicopter 96, and a ship 94. The term transportation vessel may refer to any aircraft, watercraft, or even vehicle that is used to transport people and/or cargo. Ideally in the present application, it is contemplated that system 101 is most advantageous with water based emergencies, however, it is understood that land emergencies are also contemplated.

System 101 is operable upon the occurrence of an emergency situation. Emergency situations may be defined as situations where the vessel becomes incapacitated or crashes. Such situations may be identified by the user/operator or also be identified by an automated control system 103. A user or operator of the vessel may selectively activate system 101. In the preferred embodiment, system 101 is activated automatically by the automated control system 103 upon detection of an emergency situation. It is preferred that system 101 is not able to be deactivated by the user/operator in order to avoid accidental deactivations. As seen in FIGS. 2-4, automated control device 103 may be associated with flight control computers 103a-b and automated navigation systems 103c for ship 94.

System 101 includes automated control system 103 and a location device 105. Control system 103 is in communication with control and navigations systems within the respective vessel. As such, control system 103 receives information related to the operational status of the vessel. Control system 103 may receive information from impact detection systems, emergency systems, activation of systems used when in distress, and other key systems that are built in to the vessel. With respect to a watercraft, control system 103 may receive information related to the roll or tilt of the vessel. If the roll is maintained above a preselected amount for a durational limit then an emergency situation has occurred. Similarly, when control system 103 receives data regarding water levels within the hull exceeding a preselected level, an emergency situation has occurred. With respect to aircraft, control system 103 may receive data related to elevation, accelerometer data, and general flight conditions. Where such detection or emergency systems are not included within the vessel, control system 103 may include programing to provide such capabilities.

Location device 105 is coupled to structural portions of the vessel. This may be the airframe or hull for example. It is desired that location device 105 be associated with the larger and more structurally rigid body members in size and weight. Upon a crash, whether in land or water, larger body members stand more chance of surviving with the least damage or disintegration. Exemplary locations for control systems 103a-c are illustrated in FIGS. 2-4. It is understood that other locations beyond that shown in the figures are feasible and appropriate in view of the present disclosure.

When control system 103 detects or receives data determining an emergency situation (i.e. a crash or sinking for example), control system 103 automatically deploys location device 105. Location device 105 includes a tether 107 and an elevation device 109 configured to be selectively deployed upon the occurrence of an emergency situation. Location device 105 serves as a location indicator of the approximate location of the vessel. When an accident occurs over water, aircraft 98, 96 and ship 94 may sink. Currents and depth of the water may act to spread the wreckage. In this way, location device 105 acts as an approximate location indicator. When an accident occurs on land, wreckage is typically more contained to a specific discernable area.

Elevation device 109 is configured to signal the location of the vessel. Elevation device 109 is configured to have a greater buoyancy than at least one of air and water. Elevation device 109 may be thought of as a balloon that is inflated with a gaseous mixture to permit floating in water and air. When deployed, elevation device 109 is inflated and rises in elevation. This permits elevation device 109 to extend a distance above the wreckage. Inflation may be made in a manner similar to life jackets where the pulling of a cord releases a compressed gas cartridge used to inflate device 109. In another embodiment, it is understood that elevation device 109 may be simply a floatation device for use in water emergencies where device 109 is designed to float atop the surface of the water. System 101 may include one or more elevation devices 109 along tether 107.

Tether 107 extends between elevation device 109 and the vessel, and is used to prevent elevation device 109 from floating away. Tether 107 may be made from a plurality of materials and consist of multiple types of weaves, contours, and shapes. For example, tether 107 may be any of a hose, rope, wire, or cord to name a few. The strength of tether 107 is sufficient to bias the buoyancy force of elevation device 109. Where tether 107 is a hose, tether 107 may be internally routed to accept a sealed passage 111 (see FIG. 6) of gas for use in inflating elevation device 109.

System 101 may further include a motor 113 and a pump 115. Control system 103, motor 113 and pump 115 are all in communication with each other. This allows pump 115 and motor 113 to be operably controlled by control system 103. Motor 113 is used to selectively release elevation member 109 to a preselected length. Motor 113 may be commanded by control system 103 to further release more tether or to retract some of tether 107 back within the housing of location device 105. When system 101 is equipped with motor 13, control system 103 selects and may further adjust the length of tether 107 depending on many different criteria, such as at least one of the following: type of vessel; type of emergency; and location of the vessel.

As stated previously, elevation device 109 may be inflated in a manner similar to that of life preservers that are inflated with the pull of a cord. It was also disclosed that gas may be passed through tether 107 to inflate device 109. Pump 115 may further be included within system 101 to provide gas to device 109. An advantage of using pump 115 is the ability for control system 103 to selectively release or retract gas from elevation member 109. Control system 103 has the ability to adjust the air pressure within device 109 to vary buoyancy forces. Use of motor 113 and pump 115, permit control system 103 to control the location of elevation device 109 with respect to the vessel in some degree.

Referring now also to FIGS. 5 and 6, additional components associated with system 101 are illustrated. FIGS. 5 and 6 are similar in form and function to one another. FIG. 6 is used to illustrate the use of passage 111 described previously. System 101 may further include a visual indicator and/or a beacon. Both the visual indicator and the beacon are configured to increase the visibility and detectability of the wreckage to an outside onlooker or searcher. Both are coupled to tether 107 and become exposed and activated as it is deployed. One or more visual indicators and/or beacons may be dispersed along tether 107.

Visual indicators are focused on detection through visual observation. A visual indicator may be a flag 117, a light 118, and/or a reflector 119. An example of another visual indicator is the use of color. Tether 107 and device 109 may be colored in assorted patterns and colors to increase detection.

Beacons are focused on detection through audible or electronic observation. A beacon may include a sound beacon 121 or a signal beacon 123. Sound beacons 121 emit an audible noise. The noise is preselected to a selected frequency and amplitude. Control system 103 may optionally be configured to selectively adjust the amplitude and frequency of sound beacon 121. Signal beacon 123 is configured to emit an electronic signal detectable via electronic tracking equipment (i.e. radar). Each acts similarly to a homing beacon or distress signal. Each beacon is configured to activate automatically and is operable through battery power individually associated with each beacon. Naturally, each beacon is waterproof.

An advantage of system 101 can easily be seen with the use of the beacons in the event of a crash in the ocean. It is known that sound travels differently at different temperatures, depths, and with different salinity. A wreckage in an ocean may leave the wreckage at the bottom more than a mile below the surface. At such depths, the remains of the wreckage are difficult if not impossible to detect with existing systems. System 101, however, is able to release elevation device 109 and accompanying beacons (121,123). Device 109 extends toward the surface passing through various temperature bands and salinity bands in the ocean. Where location device 105 uses multiple beacons (121,123) dispersed along tether 107, the sounds and signals emitted will be located in a variety of differing bands within the water thereby affording a greater chance of the signal being detected by search equipment. Therefore, location device 105 is configured to extend through different salinity bands and temperature bands within the ocean to maximize the detectable range of the beacon (121,123).

The ability to selectively adjust the length of tether 107 after a crash or emergency situation has appeared is made possible through the use of an optional independent power supply configured to operate system 101. Independent power is supplied for a period of time to allow for the adjustment of air pressure within elevation device 109 and the length of tether 107.

The current application has many advantages over the prior art including at least the following: (1) increase detectability of a vessel in an emergency; (2) automated deployment; (3) inability to be deactivated by an operator; (4) emit signals and sounds through different temperature and salinity bands within the ocean; (5) selective inflation of the elevation device; (6) selective adjustment of the tether length.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A location detection system for a transportation vessel, comprising:
an automated control system within the transportation vessel being configured to detect an emergency situation;
a location device coupled to the structure of the transportation vessel and in communication with the automated control system, the location device including:
an elevation device configured to signal the location of the transportation vessel; and
a tether coupled between the structure of the transportation vessel and the elevation device;
wherein the automated control system is configured to automatically deploy the location device upon detection of an emergency situation, the inflation device remaining coupled to the structure via the tether.

2. The location detection system of claim 1, wherein the location device is inflatable.

3. The location detection system of claim 2, wherein the tether is internally routed to accept the sealed passage of a gas, the gas used to inflate the elevation device.

4. The location detection system of claim 1, wherein the transportation vessel is an aircraft.

5. The location detection system of claim 4, wherein the automated control system is a flight control system for an aircraft.

6. The location detection system of claim 1, wherein the transportation vessel is a watercraft.

7. The location detection system of claim 6, wherein the automated control system is a navigation system for a watercraft.

8. The location detection system of claim 7, wherein the automated control system includes a sensor configured to detect roll or tilt of the vessel and water level within a hull of the watercraft.

9. The location detection system of claim 7, wherein the location device is deployed when the roll is maintained above a preselected amount for a durational limit.

10. The location detection system of claim 7, wherein the location device is deployed when the sensor detects water within the hull above a preselected level.

11. The location detection system of claim 1, further comprising:
a visual indicator configured to signal the location of the vessel, the visual indicator coupled to the tether.

12. The location detection system of claim 1, further comprising:
a beacon configured to signal the location of the vessel electronically, the beacon emitting at least one of an audible sound and an electronic signal.

13. The location detection system of claim 12, wherein the location device is configured to extend through different salinity and temperature bands within a body of water to maximize the detectable range of the beacon.

14. The location detection system of claim 1, wherein the control system selects the length of the tether released depending at least upon the type of vessel, the type of emergency situation, and location of the vessel.

15. A method of signaling the location of a transportation vessel in an emergency situation, comprising:
detecting the emergency situation through an automated control system within the transportation vessel; and
deploying a location device automatically upon detection of the emergency situation, the location device being coupled to the structure of the transportation vessel and in communication with the automated control system, deploying the location device including:
releasing an elevation device configured to have a greater buoyancy than at least one of water and air, the elevation device remaining coupled to the transportation vessel.

16. The method of claim 15, further comprising:
inflating the elevation device upon deployment.

17. The method of claim 15, further comprising:
activating one or more beacons dispersed along a tether, the tether coupling the elevation device to the structure.

18. The method of claim 17, wherein the beacons emit at least one of an audible sound and an electronic signal to identify the location of the vessel.

19. The method of claim 15, further comprising:
adjusting air pressure within the elevation device.

20. The method of claim 15, further comprising:
selectively controlling the location of the elevation device relative to the transportation vessel.
